(19) United States
(12) Patent Application Publication
(10) Pub. No.: US 2015/0191211 A1
(43) Pub. Date: Jul. 9, 2015

(54) AERODYNAMIC STRAW AND STRAW MOUNT

(71) Applicant: FELT RACING, LLC, Irvine, CA (US)

(72) Inventor: Anton A. Petrov, Lake Forest, CA (US)

(73) Assignee: FELT RACING, LLC, Irvine, CA (US)

(21) Appl. No.: 14/149,692

(22) Filed: Jan. 7, 2014

(51) Int. Cl. B62J 11/00; B62J 99/00

(52) U.S. Cl. CPC B62J 11/00; B62J 99/00

(57) ABSTRACT

An aerodynamic straw and a straw mount for selectively positioning the aerodynamic straw is disclosed. In this manner, a mouthpiece of the straw can be optimally positioned so that the rider need only move his or her head slightly to bite down on the mouthpiece and hydrate him or herself during a ride. In this manner, the rider can maintain the aerodynamic tucked in position while riding a road bicycle.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to an aerodynamic straw and a straw mount for aerodynamically positioning a straw on a bicycle.

In road cycling racing events, riders ride their bicycles over an extended period of time. Throughout this period of time, the rider must stay hydrated. To this end, the rider will store water or a hydration fluid in a bottle mounted to the bicycle or backpack. In order to hydrate oneself, the rider must release one hand from the handlebar to grab the water bottle. Additionally, the rider must sit upright to invert the water bottle and drink the fluid therein. Such movements create aerodynamic inefficiencies.

Accordingly, there is a need in the art for an improved method and device for hydration while riding a bicycle.

### BRIEF SUMMARY

The various embodiments and aspects disclosed herein address the needs discussed above, discussed below and those that are known in the art.

An aerodynamic straw is disclosed which is aerodynamically positioned so that a mouthpiece of the aerodynamic straw is juxtaposed to the rider's mouth. When the rider needs to hydrate him or herself, the rider need only move his or her head slightly so that his or her mouth may bite down on the mouthpiece of the straw and suck in the fluid delivered by way of the straw which is connected to a hydration storage container located elsewhere either on the bicycle or rider. Additionally, the straw may be adjusted front to back as well as tilted in order to optimally position the mouthpiece of the straw immediately adjacent to the mouth of the rider.

More particularly, a straw mount for positioning an upper distal end of a straw adjacent to a rider's mouth when riding a road bicycle is disclosed. The mount may comprise a first member, a second member and a liquid tube. The first member may be attachable to a handlebar of the bicycle. The first member may have a plurality of radially extending teeth. The second member may be rotatable with respect to the first member. The second member may have a corresponding plurality of radially extending teeth. The liquid tube may be in fluid communication with and provide liquid to the rider's mouth from a water storage compartment. The liquid tube and more particularly the mouthpiece attached to the upper distal end of the tube may be positioned by rotating the second member to the first member for aerodynamic purposes.

The second member may be displaced away from the first member to disengage the teeth of the first and second members to allow for rotation of the second member with respect to the first member. The second member may be biased toward the first member to engage the teeth of the first and second members to prevent rotation of the second member with respect to the first member after the unit is set in place. The second member may be biased toward the first member with a compression spring.

In another aspect, an aerodynamic straw to deliver liquid from a liquid bladder to a mouth of a bicycle rider is disclosed. The straw may comprise a tube having a lumen for delivering the liquid from the liquid bladder to the mouth of the bicycle rider. The lumen may be sized and configured to allow for water flow so that the rider may drink from the straw. An exterior surface of the tube may have an aerodynamic cross sectional configuration. The aerodynamic cross sectional configuration may be oval. The oval cross section may have a front half which is substantially identical to a back half of the tube. A maximum thickness of the tube may be at about 50% of a chord length of the oval cross section of the tube.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a straw mount and an aerodynamic tube;

FIG. 2 is an enlarged view of the straw mount shown in FIG. 1;

FIG. 3 is a cross-sectional view of the straw mount with teeth in an engaged position;

FIG. 4 illustrates the straw mount shown in FIG. 3 with the teeth in a disengaged position; and

FIG. 5 is a cross-sectional view of the aerodynamic straw shown in FIG. 1.

### DETAILED DESCRIPTION

Referring now to the drawings, an aerodynamic straw 10 and a method for using the same is disclosed. The aerodynamic straw 10 has an aerodynamic cross-sectional configuration in the direction of airflow (i.e., bicycle forward travel) to minimize drag. Moreover, the aerodynamic straw 10 has a mouthpiece 12 that can be placed at a plurality of positions front to back so that the mouthpiece 12 is located closely adjacent to a bicycle rider's mouth. In this manner, when the rider desires to hydrate him or herself, the rider need only bite down on the mouthpiece 12 and drink water. The rider does not need to move his or her body position and hands to drink water. Accordingly, the aerodynamic tucked in position of the rider does not need to be disturbed to drink hydration liquid. Accordingly, the aerodynamic tucked in position can be maintained for a longer period of time and is not interrupted by the need to hydrate. The aerodynamic straw 10 has an aerodynamic structural configuration and also its use allows the user to maintain the aerodynamic tucked in position for a longer period of time.

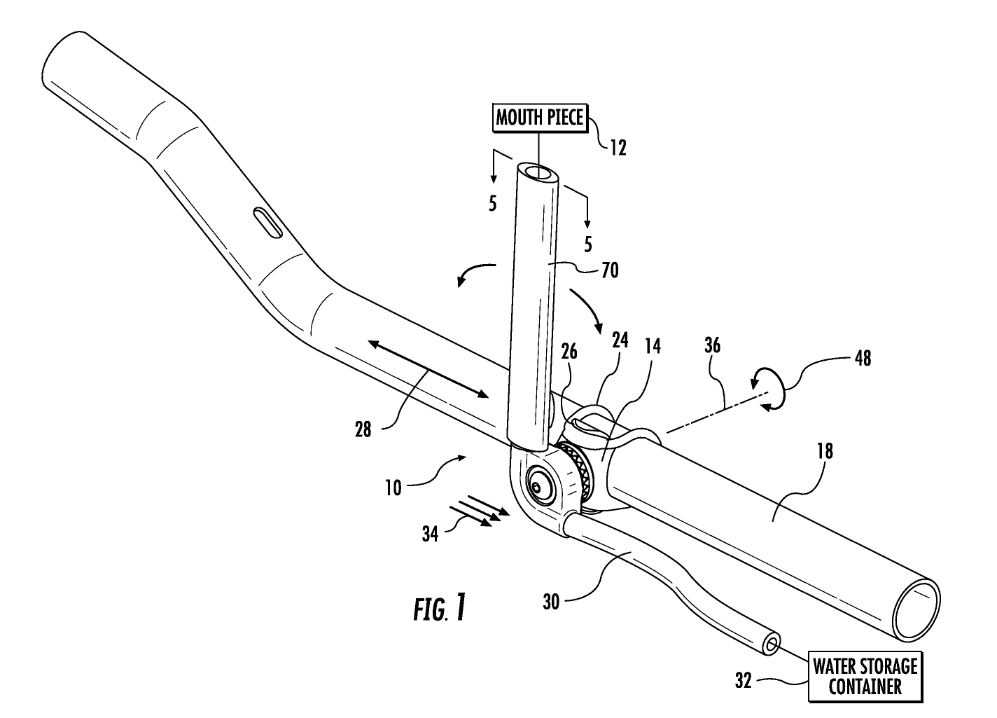

More particularly, referring now to FIG. 1, the aerodynamic straw 10 may be mounted to a handlebar of a bicycle. The aerodynamic straw 10 may be mounted to one of two aerobars of the road bicycle, as shown in FIG. 1. The aerodynamic straw 10 has a mounting member 14. An inner surface 16 of the mounting member 14 may have a curved configuration that corresponds to the configuration of the aerobar 18. The aerobar 18 is typically an extension mounted off of the handlebar of the road bicycle so that the rider can lean on the aerobars 18 with his or her forearms to more comfortably maintain the aerodynamic tucked in position. The mounting member 14 may have two hooks 20, 22. To mount the aerodynamic straw 10 to the aerobar 18, the inner surface 16 is placed against the outer surface of the aerobar 18. An oval elastic member 24 is hooked around one of the two hooks 20, 22. The other end of the oval elastic member 24 is engaged to the other one of the two hooks 20, 22. In FIG. 1, the oval elastic member 24 is hooked around the lower hook 22. A finger tab 26 is used to stretch the oval elastic member 24 open so that the oval elastic member 24 can engage the upper hook 20.

The aerodynamic straw 10 is positioned along the longitudinal length 28 of the aerobar 18 so that a tube 30 that extends back to a water storage container 32 is generally straight. When the bicycle is moving forward, the air is moving in the direction of arrow 34. The tube 30 should be generally in line with the air direction to cause as little aerodynamic drag during riding. Accordingly, the frontal profile of the tube 30 would ideally be the cross-section of the tube 30 to minimize aerodynamic drag. To keep the tube straight, the rider or person installing the aerodynamic straw 10 may cut the tube 30 so that when the rider is in the aerodynamic tucked in position, the mouthpiece 12 of the aerodynamic straw 10 is located juxtaposed to the rider's mouth. To drink water, the rider need only lower his or her head slightly so that the rider can bite down on the mouthpiece 12 to drink water. With the tube 30 cut to the proper length to achieve aerodynamic benefits, the mounting member 14 may be secured to the aerobar 18 to properly position the tube 70 for aerodynamic purposes.

In certain situations either the tube 30 cannot be cut to the proper length to position the mouthpiece 12 near the rider's mouth or minute positional adjustments may be necessary to position the mouthpiece 12 so that the rider can conveniently bite down on the mouthpiece 12 while riding the bicycle in an aerodynamic tucked in position. To this end, the aerodynamic straw 10 allows the rider or installer to move the mouthpiece 12 front or back by rotating the mouthpiece 12 about a pivot axis 36. To rotate the mouthpiece 12, the aerodynamic straw 10 has a joint 38 or knuckle that allows the user to rotate and lock the position of the mouthpiece 12.

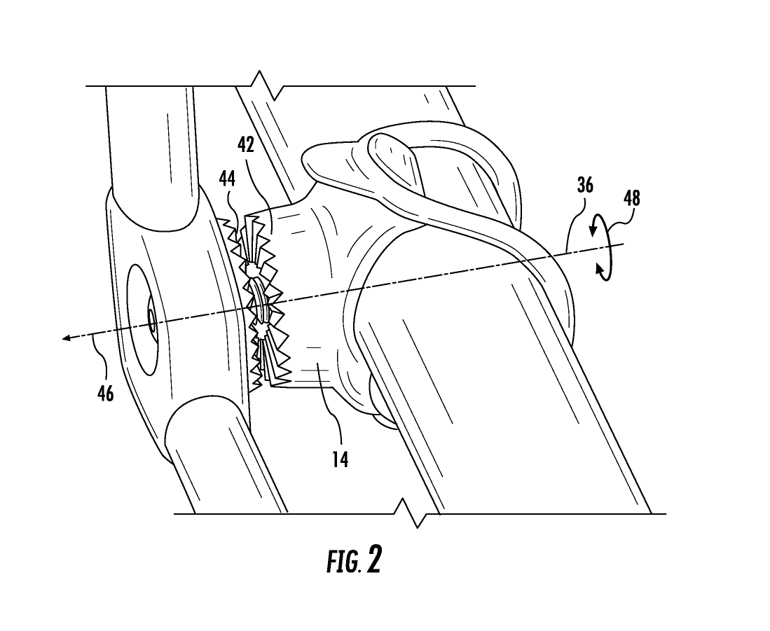

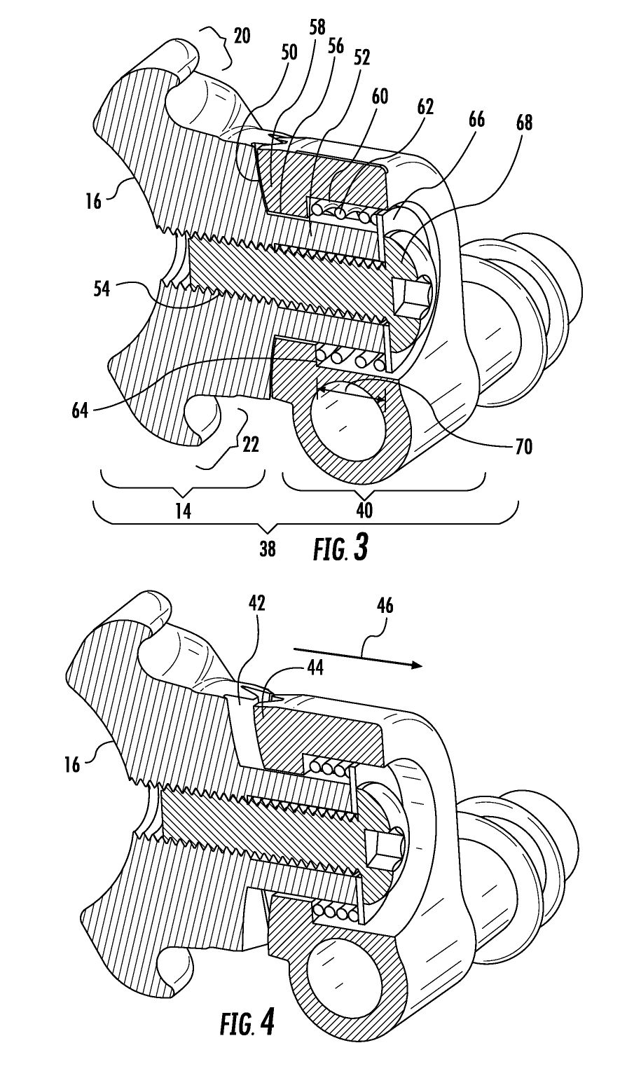

The joint 38 includes the mounting member 14 and a straw member 40. The mounting member 14 and the straw member 40 have corresponding interlocking pieces 42, 44. The straw member 40 is normally biased so that the teeth 42, 44 are engaged to each other as shown in FIGS. 1 and 3. In the engaged position, the position of the mouthpiece 12 is locked in place. To adjust the front to back positioning of the mouthpiece 12, the user may pull on the straw member 40 in the direction of arrow 46 along pivot axis 36, as shown in FIG. 2. This overcomes the biasing force that biases the straw member 40 against the mounting member 14. At this point, the teeth 42, 44 become disengaged and the straw member 40 may be rotated about the pivot axis 36 as per directional arrow 48. The user releases the straw member 40 and the straw member is biased back against the mounting member 14 so that the teeth 42, 44 are engaged and lock the rotational position of the straw member 40.

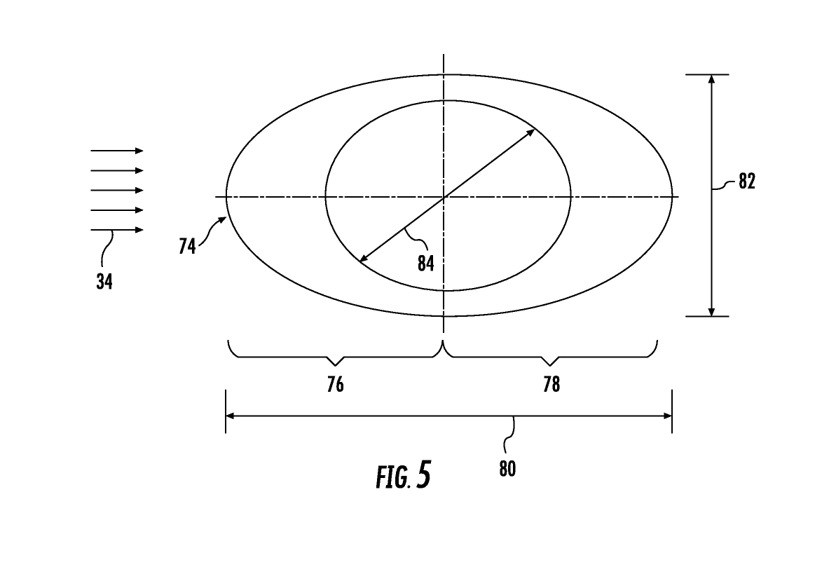

Referring now to FIGS. 3 and 4, the internal structure of the joint 38 is shown. The joint 38 includes the mounting member 14 and the straw member 40. The mounting member 14 has a shoulder 50 and a protrusion 52. The protrusion 52 extends outward from the shoulder 50 and may include a threaded hole 54. The straw member 40 has a through hole 56 which is sized and configured to receive the protrusion 52 of the mounting member 14. The straw member 40 has a base surface 58 that rests on the shoulders 50 of the mounting member 14 when the teeth 42, 44 of the mounting member 14 and the straw member 40 are engaged to each other, as shown in FIG. 3.

The protrusion 52 extends through the through hole 56 of the straw member 40. The protrusion 52 is seated onto the inner surface of the through hole 56 so that as the straw member 40 is pulled out and released, the straw member 40 is relatively stable. An enlarged cavity 60 is formed beyond the throughhole 56. The enlarged cavity 60 receives the protrusion 52 and a compression spring 62. The compression spring 62 is seated on a bottom surface 60 formed by the enlarged cavity 60. The other end of the compression spring 62 is seated on a washer 66 having a diameter greater than the outer diameter of the protrusion 52. The washer 66 and spring 62 are attached to the protrusion 52 by way of bolt or screw 68.

The distance 70 between the bottom surface 64 of the enlarged cavity 60 and the washer 66 and the length of the spring 62 are sized so that the spring 62 places slight pressure to bias the teeth 42, 44 of the mounting member 14 and the straw member 40 into engagement. Also, the spring 62 and the distance 70 are sized to allow the user to pull the straw member 40 in the direction of arrow 46 to disengage the teeth 42, 44 of the mounting member 14 and the straw member 40, as shown in FIG. 4.

Referring back to FIG. 1, a tube 72 may extend out from the straw member 40. The tube 72 is in fluid communication with the tube 30 which is in fluid communication with the water storage container 32. The water storage container 32 may be a flexible bladder mounted to the bicycle handlebar or frame or a water bottle disposed in a water bottle cage on the down tube or seat tube of the bicycle frame. The water storage container 32 may also be a semi rigid or rigid container mounted to the handlebar or frame of the bicycle. The tube 72 may extend generally upward during use so that rider may reach downward and bite down on the mouthpiece attached to the upper distal end of the tube 70 to drink liquid.

The tube 70 may have an aerodynamic cross sectional configuration, as shown in FIG. 5. The leading surface or edge may have an arc shape. By way of example, the leading surface or edge may have a cylindrical shape. The National Advisory Committee for Aeronautics (hereinafter “NACA”) has developed a numbering system that identifies the major characteristics of an airfoil shape. The NACA numbering system may include four (4) digits (i.e., xxxx) which the first two digits define the camber angle (i.e., xxxx) and the last two digits define a maximum thickness (i.e., xxxx) of the airfoil shape as a percentage of a chord length of the airfoil shape. The NACA numbering system may be followed by a dash (-) with two (2) numbers. The first (i.e., xxxx-xx) of the two numbers following the dash (-) indicates the roundness of the leading surface 40 and may be represented by the letter “I”. A value of six (6) indicates that the leading surface 40 has a radius similar to a typical airfoil shape while a value of zero (0) indicates a sharp leading edge. The typical airfoil shape has a round (i.e., circular or arc) leading surface 40 approximated by the following equation, r=1.1019×(I×t/6)² wherein “t” is the maximum thickness of the airfoil shape as a fraction of the chord length and “I” is equal to 6. This “r” value represents a NACA numbering system xxxx-6x. The roundness of the leading surface 74 discussed herein for the improved airfoil shape for bicycle may be in a range between xxxx-1x to xxxx-5x. Preferably, based on the NACA standard, the roundness of the leading surface 40 is about xxxx-4x. The radius of the leading surface for the NACA numbering system xxxx-4x is equal to r=1.1019×(3×t/6)². Preferably, the leading surface 74 has a roundness of NACA 0053-45. The tube 74 is designed so that the front half 76 is identical to the back half 78. The tube 74 is designed so that the maximum thickness is about 50% a chord length of the cross sectional configuration.

The tube 74 may be extruded. However, due to the tube 74 being oval (i.e., non-round), the polymeric material does not deform uniformly after exiting the die of the extruder. As such, the length 80 to width 82 ratio of the cross sectional configuration of the tube 74 is designed to be 1.86 to 1, but the production tube 74 has an aspect ratio of 1.41 to 1. The length 80 of the tube 74 is preferably about 16.3 mm and the width 82 about 11.5 mm. The length 80 of the tube may be up to about 35 mm with the width 82 being no more than 15 mm. As such, the range of length 80 to width 82 ratios may be about 1.3:1 to 4:1. The inner diameter 84 of the tube 70 is sized to the outer diameter of the inlet of the mouthpiece 12. In particular, stem of the mouthpiece or drinking bite valve inlet has an outer diameter of 8 mm, whereas the inner diameter 84 of the tube 74 has a production inner diameter of about 7.6 mm. However, it is contemplated that the inner diameter 84 of the tube 74 has a production inner diameter of about 6 mm to about 9 mm.

More broadly, the outer cross-sectional configuration of the tube 74 may be non-round but also aerodynamic in the direction of airflow while the bicycle is moving forward. The outer cross-sectional size of the tube 74 is limited to an inner diameter 84 sufficient for water flow to hydrate the rider. Additionally, the tube 74 does not require a cover for aerodynamic purposes. The exterior surface of the tube 74 is shaped to an aerodynamic configuration.

The above description is given by way of example, and not limitation. Given the above disclosure, one skilled in the art could devise variations that are within the scope and spirit of the invention disclosed herein, including various ways of attaching the mounting member to the aerobar. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A straw mount for positioning an upper distal end of a straw adjacent to a rider's mouth when riding a road bicycle, the mount comprising:
a first member being attachable to a handlebar of the bicycle, the first member having a plurality of radially extending teeth;
a second member being rotatable with respect to the first member, the second member having a corresponding plurality of radially extending teeth;
a liquid tube for providing liquid to the rider's mouth from a water storage compartment, the liquid tube being positionable based on the rotation of the second member to the first member.

2. The straw mount of claim 1 wherein the second member is displaceable away from the first member to disengage the teeth of the first and second members to allow rotation of the second member with respect to the first member.

3. The straw mount of claim 2 wherein the second member is biased toward the first member to engage the teeth of the first and second members to prevent rotation of the second member with respect to the first member.

4. The straw mount of claim 3 wherein the second member is biased toward the first member with a compression spring.

5. An aerodynamic straw to deliver liquid from a liquid bladder to a mouth of a bicycle rider, the straw comprising:
a tube having a lumen for delivering the liquid from the liquid bladder to the mouth of the bicycle rider, the lumen being sized and configured to allow for water flow so that the rider may drink from the straw;
wherein an exterior surface of the tube has an aerodynamic cross sectional configuration.

6. The straw of claim 5 wherein the aerodynamic cross sectional configuration is oval.

7. The straw of claim 6 wherein oval cross section defines a front half which is substantially identical to a back half of the tube.

8. The straw of claim 6 wherein a maximum thickness of the tube is at about 50% of a chord length of the oval cross section of the tube.
